(19) United States
(12) Patent Application Publication
(10) Pub. No.: US 2011/0311853 A1
(43) Pub. Date: Dec. 22, 2011

(54) ELECTROCHEMICAL CELL SYSTEM AND APPARATUS TO PROVIDE ENERGY TO A PORTABLE ELECTRONIC DEVICE

(75) Inventor: Roger A. Fratti, County of Berks, PA (US)

(73) Assignee: LSI CORPORATION, Milpitas, CA (US)

(21) Appl. No.: 12/817,207

(22) Filed: Jun. 17, 2010

(51) Int. Cl. H01M 2/10; H01M 6/00; H01M 2/24

(52) U.S. Cl. 429/100; 429/160; 429/122

(57) ABSTRACT

A planar galvanic cell arrangement for portable electronic device is provided. In one embodiment, a galvanic cell arrangement may include a flexible substrate including a surface area that forms a plane. The galvanic cell arrangement also includes a plurality of galvanic cells coupled with the flexible substrate within the surface area that forms the plane, and electrically connected with one another in series, each of the plurality of galvanic cells including a negative electrode and a positive electrode. Furthermore, the galvanic cell arrangement includes a first terminal coupled with the negative electrode at one end of the series, and second terminal coupled with the positive electrode at an opposite end of the series. The plurality of galvanic cells being configured to provide electrical power to the portable electronic device via the first and second terminal, based on the plurality of galvanic cells being exposed to an aqueous electrolyte.

### FIELD OF TECHNOLOGY

This disclosure relates generally to a technical field of electrical energy and, in one example embodiment, to an electrochemical cell system and apparatus to provide energy to a portable electronic device.

### BACKGROUND

A common power supply is an electrical battery (referred to hereinafter as “battery”) A battery may include multiple electrochemical cells that convert stored chemical energy into electrical energy. The battery may then use the electrical energy produced by the multiple cells to power and electrically powered object such as a mobile phone, power tool, and the like.

In an electrochemical cell, the conversion of chemical energy to electrical energy may involve exposure of electrodes within the electrochemical cell to an electrolyte or each to different electrolyte. Some batteries may use an “aqueous” electrolyte that is in a substantially liquid state. A battery may alternatively or additionally use a “dry” electrolyte that is relatively more solid than the aqueous solution.”

### SUMMARY

In one aspect, a galvanic cell arrangement to provide electrical power to a portable electronic device is described. The galvanic cell arrangement includes a flexible substrate including a surface area that forms a plane. The galvanic cell arrangement also includes a plurality of galvanic cells coupled with the flexible substrate within the surface area that forms the plane, and electrically connected with one another in series, each of the plurality of galvanic cells including a negative electrode and a positive electrode.

In addition, the galvanic cell arrangement includes a first terminal coupled with the negative electrode at one end of the series, and second terminal coupled with the positive electrode at an opposite end of the series. The galvanic cell arrangement also includes the plurality of galvanic cells being configured to provide electrical power to the portable electronic device via the first and second terminal, based on the plurality of galvanic cells being exposed to an aqueous electrolyte. The negative electrode of each of the plurality of galvanic cells may include a zinc anode and the positive electrode of each of the plurality of galvanic cells may include a copper cathode. The plurality of galvanic cells may include a number of galvanic cells that may depend on a voltage requirement of the portable electronic device, and cell potential of each galvanic cell of the plurality of galvanic cells may be exposed to the aqueous electrolyte.

The galvanic cell arrangement may also include a cell isolator positioned to surround, may be partially. Each of the plurality of galvanic cells may electrically isolate the plurality of galvanic cells from one another. The cell isolator may include cell overlay element positioned may be adjacent to each of the plurality of galvanic cells and may be configured to electrically isolate the plurality of galvanic cells from one another. The overlay element may include an electrolyte facing portion configured to absorb the aqueous electrolyte, and a cell facing portion configured to expose the aqueous electrolyte to the plurality of galvanic cells, and may be one cell separator element positioned may be adjacent to each of the plurality of galvanic cells, and configured to electrically isolate the plurality of galvanic cells from one another. The separator may be less absorptive than the overlay element.

The cell overlay element may be characterized by a porosity that may permit the cell facing portion to expose the plurality of galvanic cells to the aqueous electrolyte at a specific exposure rate that relate to an acidity level of the aqueous electrolyte. A portion of the flexible substrate may be configured to couple with the portable electronic device. The portable electronic device may be configured to operate under water, and the aqueous electrolyte may include a solution of sodium and water. A portion of the flexible substrate may be configured to couple with the portable electronic device. The portable electronic device may include a portable audio player, and the aqueous electrolyte may include human perspiration. The portable electronic device may include a probe that may be ingestible by an animal and the aqueous electrolyte may include a gastric acid solution.

In another aspect, an electrochemical cell arrangement includes a base member including a planar surface area. The electrochemical cell arrangement also includes one pair of electrodes coupled with the planar surface area of the base member, and including a negative electrode and a positive electrode. The electrochemical cell arrangement further includes one pair of electrodes being configured to operate as a voltage source responsive to one pair of electrodes being exposed to an aqueous electrolyte. The negative electrode may include a metallic anode and the positive electrode may include a metallic cathode. One or more pair of electrodes may include a plural number of pairs of electrodes that depend on a voltage requirement, a cell potential of each pair of electrodes of the plural number of pairs of electrodes, and a constitution of the aqueous electrolyte. The plural number of pairs of electrodes may be electrically connected in series. The plural number of pairs of electrodes operating as the voltage source may be configured to provide a voltage based on a summation of the cell potential of each pair of electrodes of the plural number of pairs of electrodes.

The electrochemical cell arrangement may also include one or more cell separation elements positioned may be adjacent to, may be partially, each of the plural number of pairs of electrodes to electrically isolate, from one another, each of the plural number of pairs of electrodes. In addition, the electrochemical cell arrangement may also include a cell overlay element positioned adjacent to the plural number of electrodes and may include an electrolyte facing portion which may be configured to absorb the aqueous electrolyte, and an electrode facing portion configured to expose the plural number of pairs of electrodes to the aqueous electrolyte at a rate of exposure. The cell overlay element may be characterized by a porosity that allow the electrode facing portion to expose a particular aqueous electrolyte to the plural number of pairs of electrodes at a specific rate of exposure. One or more pair of electrodes may be configured to power a portable electronic device when one or more pair of electrodes may be exposed to the aqueous electrolyte.

The electrochemical cell arrangement may also include a securing mechanism that may be configured to be coupled with the portable electronic device and to retain one or more pair of electrodes. Furthermore, the electrochemical cell arrangement may also include a releasing mechanism arranged with the securing mechanism and may be configured to release the retained one or more pair of electrodes from the securing mechanism. The securing mechanism and the releasing mechanism may permit one or more pair of electrodes to be field replaceable by a user. The base member may be configured to couple with the portable electronic device, the portable electronic device may be configured to operate under water, and the aqueous electrolyte may include saline water. The base member may be configured to attach with an animal and the aqueous electrolyte may include a bodily fluid of the animal.

In yet another aspect, a portable electronic system includes a housing including a flat external surface. The portable electronic system also includes an electronic circuit positioned within the housing and configured to perform a function of the portable electronic system. In addition, the portable electronic system includes a plurality of galvanic cells coupled with the flat external surface of the housing, and electrically connected to one another in series, each of the plurality of galvanic cells including a negative electrode and a positive electrode. The portable electronic system also includes a first terminal coupled to the negative electrode at one end of the series, and second terminal coupled with the positive electrode at an opposite end of the series. The portable electronic system further includes a cell isolator positioned to surround, partially, each of the plurality of galvanic cells so as to electrically isolate the plurality of galvanic cells from one another, the plurality of galvanic cells being configured to deliver electrical power to the electronic circuit via the first and second terminals when an aqueous electrolyte is transferred to the plurality of galvanic cells.

### BRIEF DESCRIPTION OF THE VIEWS OF DRAWINGS

Example embodiments are illustrated by way of example and not limitation in the figures of accompanying drawings, in which like references indicate similar elements and in which:

FIG. 1 illustrates a top view of an electrochemical cell arrangement, according to one or more embodiments.

FIG. 2 illustrates front view of the electrochemical cell arrangement of FIG. 1, according to one or more embodiments.

FIG. 3A illustrates a top view of a galvanic cell arrangement, according to one or more embodiments.

FIG. 3B is a table showing example voltages obtained using different number of galvanic cells in the galvanic cell arrangement, according to one or more embodiments.

FIG. 4 illustrates a further example of galvanic cell arrangement, according to one or more embodiments.

FIG. 5 illustrates an example of a portable music player powered by a planar galvanic cell arrangement, according to one or more embodiments.

FIG. 6 illustrates an example of a portable media device (e.g. portable music player powered using a galvanic cell arrangement, according to one or more embodiments.

FIG. 7 illustrates an example of a detachable battery configuration powered using a galvanic cell arrangement, according to one embodiments.

FIG. 8 illustrates an example of a clock powered using a galvanic cell arrangement, according to one or more embodiments.

FIG. 9 illustrates an example a side view of a clock powered using an example galvanic cell arrangement, according to one or more embodiments.

FIG. 10 illustrates an example of an ingestible probe powered with a conforming galvanic cell arrangement, according to one or more embodiments.

Other features of the present embodiments will be apparent from accompanying drawings and from the detailed description that follows.

### DETAILED DESCRIPTION

Disclosed are a methods, systems and an apparatus to provide. Although the present embodiments will be described below with reference to specific example embodiments, it will be evident that various modifications and changes may be made to these embodiments without departing from the broader spirit and scope of the various embodiments.

The detailed description discloses various example embodiments of an electrochemical cell that includes a pair of electrodes positioned on a planar or flat surface area and that operates as a voltage source as a result of the pair of electrodes being exposed to an aqueous electrolyte.

In various example embodiments, multiple electrochemical cells may be electrically connected to one another so as to form a battery that provides energy through its terminals. Variations of such a battery may be designed with a number and type of electromechanical cells that is appropriate to meet design constraints related to a particular applications of the battery.

In example embodiments, cell separation material may be positioned on and/or around each of the multiple electromechanical cells of the battery, having an effect of electrically isolating the multiple electromechanical cells from one another. The battery including the electrical isolation referred to above may provide more energy through its terminal than the battery without the electrical isolation.

For some example embodiments, an example battery may be used to power a portable electronic device such as a multimedia player or any other appropriate portable electronic device. The portable electronic device may operate in an environment in which the example battery is exposed to the aqueous electrolyte.

For example, the battery could be positioned with a portable music player such that the battery will contact sweat, an example aqueous electrolyte, when the portable music player is clipped to a sweaty shirt of a runner. In another example, the battery may be fixed to a diver's watch, and may power the diver's watch when the battery is submersed in sea water, another example aqueous electrolyte.

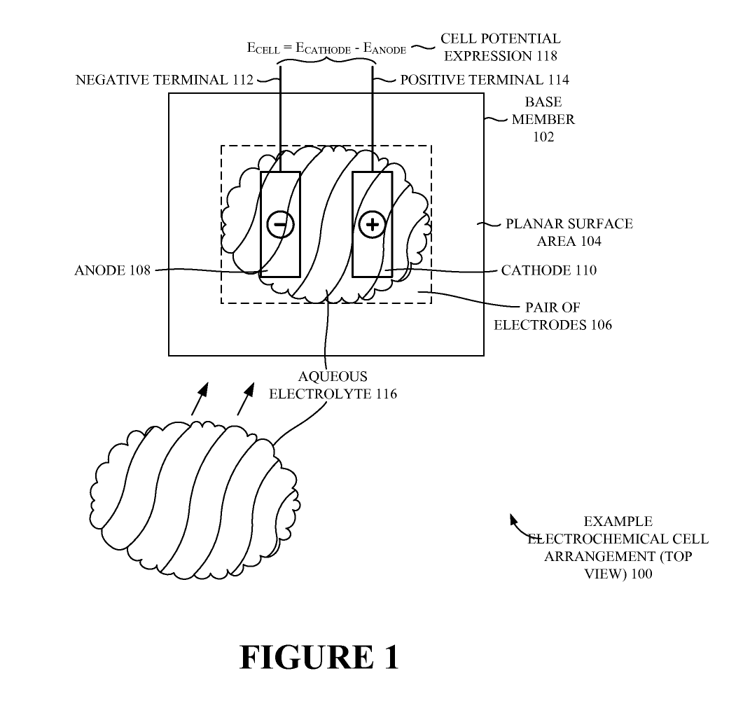

FIG. 1 illustrates a top view of an electrochemical cell arrangement 100, according to one or more embodiments. In one or more embodiments, the electrochemical cell arrangement 100 may include a base member 102 including a planar surface area 104. In one or more embodiments, a pair of electrodes 106 may be coupled with the planar surface area 104 of the base member 102 and including a negative electrode (e.g., anode 108) and a positive electrode (e.g., cathode 110). The pair of electrodes 106 may be configured to operate as a voltage source responsive to a pair of electrodes 106 being exposed to an aqueous electrolyte 116.

In one or more embodiments, the negative electrode may include a metallic anode 108 and the positive electrode includes a metallic cathode 110. In one or more embodiments, the electrodes 106 may include a multiple pairs of electrodes depending on a voltage requirement, a cell potential of each pair of electrodes 106 of the multiple pairs of electrodes, and a constitution of the aqueous electrolyte 116. The multiple pairs of electrodes 106 may be electrically connected in series. The multiple pairs of electrodes 106 operating as the voltage source may be configured to provide a voltage that may be based on a summation of the cell potential of each pair of electrodes 106 of the multiple pairs of electrodes.

A set of electrodes, anode 108 and cathode 110 may be placed in an aqueous electrolyte 116. The aqueous electrolyte 116 may be held on the base member 102. The base member may be made of a material configured to be less conductive, including but not limited to, a Kapton™ tape. This may also be flexible and conformable to different surfaces. The base member 102 may also form a planar/flat surface. In one or more embodiments, the electrochemical cell arrangement 100 may be constructed on the planar surface area 104. A negative terminal 112 from the anode 108 and a positive terminal 114 from the cathode may be used as lead connections for providing electric charge for functioning of various devices. The cell potential expression 118 for the electrochemical cell arrangement 100 may be expressed as E_{cell}=E_{cathode}−E_{anode}.

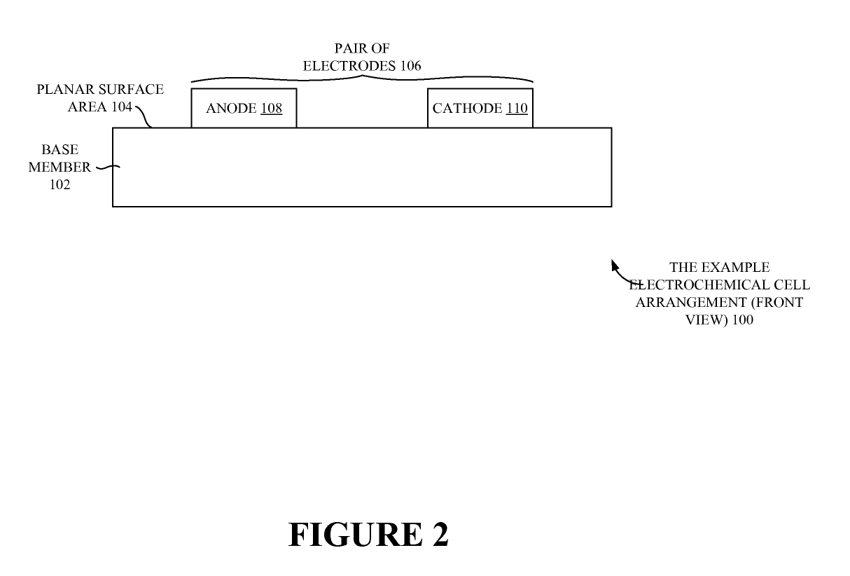

FIG. 2 illustrates front view of the electrochemical cell arrangement 100 of FIG. 1, according to one or more embodiments. The FIG. 2 illustrates the arrangement of the pair of electrodes 106 on the planar surface area 104 of the base member 102. In one or more embodiments, the electrochemical cell arrangement 100 may include one or more cell separation elements positioned partially adjacent to, each of the multiple pairs of electrodes so as to electrically isolate from one another, each of the multiple pairs of electrodes. The electrochemical cell arrangement 100 may also include a cell overlay element positioned adjacent to the multiple electrodes and including an electrolyte facing portion configured to absorb the aqueous electrolyte, and an electrode facing portion configured to expose the multiple pairs of electrodes to the aqueous electrolyte at a rate of exposure.

In one or more embodiments, the cell overlay element may be characterized by a porosity that may allow the electrode facing portion to expose a particular aqueous electrolyte to the multiple pairs of electrodes at a specific rate of exposure. One or more pair of electrodes 106 may be configured to power a portable electronic device when one or more pair of electrodes may be exposed to the aqueous electrolyte. The electrochemical cell arrangement 100 may include a securing mechanism configured to be coupled with a portable electronic device and to retain one or more pair of electrodes. In one or more embodiments, the electrochemical cell arrangement 100 may include a releasing mechanism arranged with the securing mechanism and may be configured to release the retained one or more pair of electrodes 106 from the securing mechanism, the securing mechanism and the releasing mechanism thereby permitting one or more pair of electrodes 106 to be field replaceable by a user. In one or more embodiments, the base member 102 may be configured to couple with the portable electronic device, the portable electronic device may be configured to operate under water, and the aqueous electrolyte may include saline water. In one or more embodiments, the base member 102 may be configured to attach with an animal and the aqueous electrolyte may include a bodily fluid of the animal.

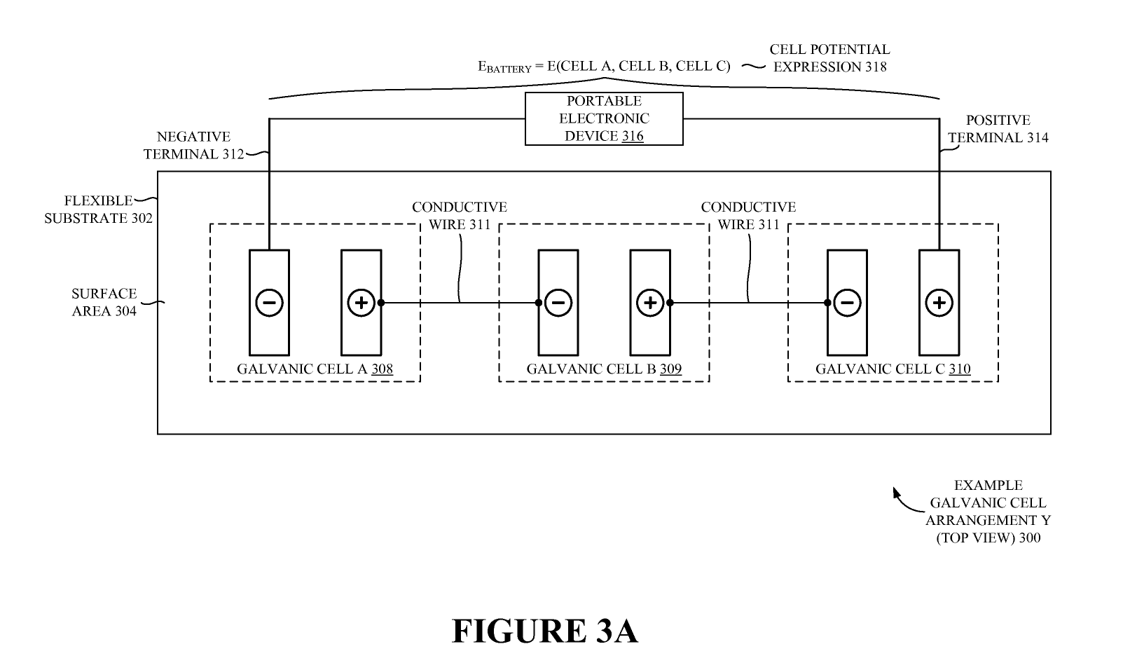

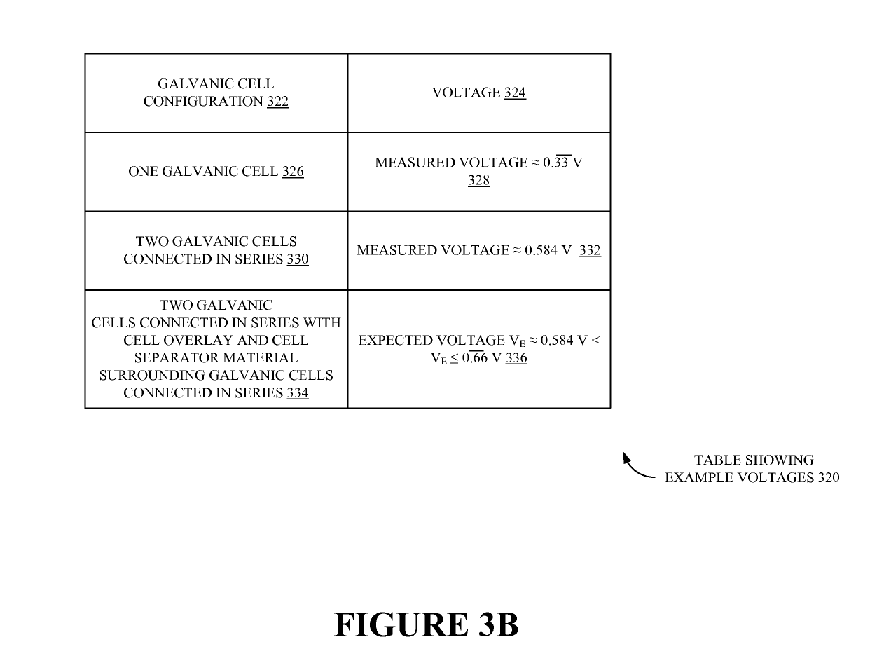

FIG. 3A illustrates a top view of a galvanic cell arrangement 300, according to one or more embodiments. In one or more embodiments, the galvanic cell arrangement 300 may be used to provide electrical power to a portable electronic device 316. Examples of the portable electronic device 316, may include, but is not limited to a mobile phone, a personal digital assistant, a digital watch, a multimedia player, a laptop, and the like. In one or more embodiments, the galvanic cell arrangement 300 may include a flexible substrate 302 including a surface area 304 that forms a plane. In one or more embodiments, the galvanic cell arrangement 300 may also include multiple galvanic cells (e.g., galvanic cell A 308, galvanic cell B 309, and galvanic cell C 310) coupled with the flexible substrate 302 within the surface area 304 that forms the plane, and may be electrically connected with one another in series, each of the multiple of galvanic cells including a negative electrode and a positive electrode. In one or more embodiments, two or more consecutive galvanic cells may be electrically connected through a conductive wire 311.

In one or more embodiments, the galvanic cell arrangement 300 may include a first terminal (e.g., a negative terminal 312) coupled with the negative electrode at one end of the series, and second terminal (e.g., a positive terminal 314) coupled with the positive electrode at an opposite end of the series. The multiple galvanic cells may be configured to provide electrical power to the portable electronic device 316 via the first terminal and second terminal, based on the multiple galvanic cells being exposed to an aqueous electrolyte. In one or more embodiments, the negative electrode of each of the galvanic cells may include a zinc anode and the positive electrode of each of the galvanic cells may include a copper cathode. For the purpose of illustration the detailed description refers to zinc anode and copper cathode; however the scope of the invention is not limited to zinc anode and copper cathode, but may be extended to include any known cathode and anode materials. In one or more embodiments, the number of galvanic cells in the galvanic cell arrangement 300 may depend on a voltage requirement of the portable electronic device 316 and a cell potential of each of the galvanic cells that may be exposed to the aqueous electrolyte. A cell potential expression 318 may be given by E_{battery}=E_{(CELL A, CELL B, CELL C)}.

FIG. 3B is a table showing example voltages 320 obtained using different number of galvanic cells in the galvanic cell arrangement 300, according to one or more embodiments. A galvanic cell configuration column 322 may indicate number of galvanic cells used to obtain a particular voltage. The voltage 324 column may indicate the measured voltages corresponding to various number of galvanic cells used. With one galvanic cell 326, a measured voltage 328 may be approximately 0.33 V. When two galvanic cells connected in series 330, the measured voltage 332 may be approximately 0.584 V. When two galvanic cells connected in series with a cell overlay and a cell separator material surrounding galvanic cells connected in series the expected voltage 336 V may be approximately in the range of 0.584 V to 0.66V. In one or more embodiments, a multiple of galvanic cells may be coupled with a flat external surface of housing, and electrically connected to one another in series. Each of the galvanic cells may include a negative electrode and a positive electrode.

A first terminal may be coupled to the negative electrode at one end of the series, and a second terminal may be coupled with the positive electrode at an opposite end of the series. In one or more embodiments, the electrode couples (anode and cathode) may be placed consecutively on one plane to form a planar arrangement. The number of electrode couples placed consecutively may depend on one or more of the required voltage drop (power), the work function of the electrodes used and the electric potential produced by one electrode couple. The planar arrangement of the galvanic cells may be used to self power the portable electronic device 316 when the galvanic cells come in contact with an electrolyte solution/an aqueous electrolyte.

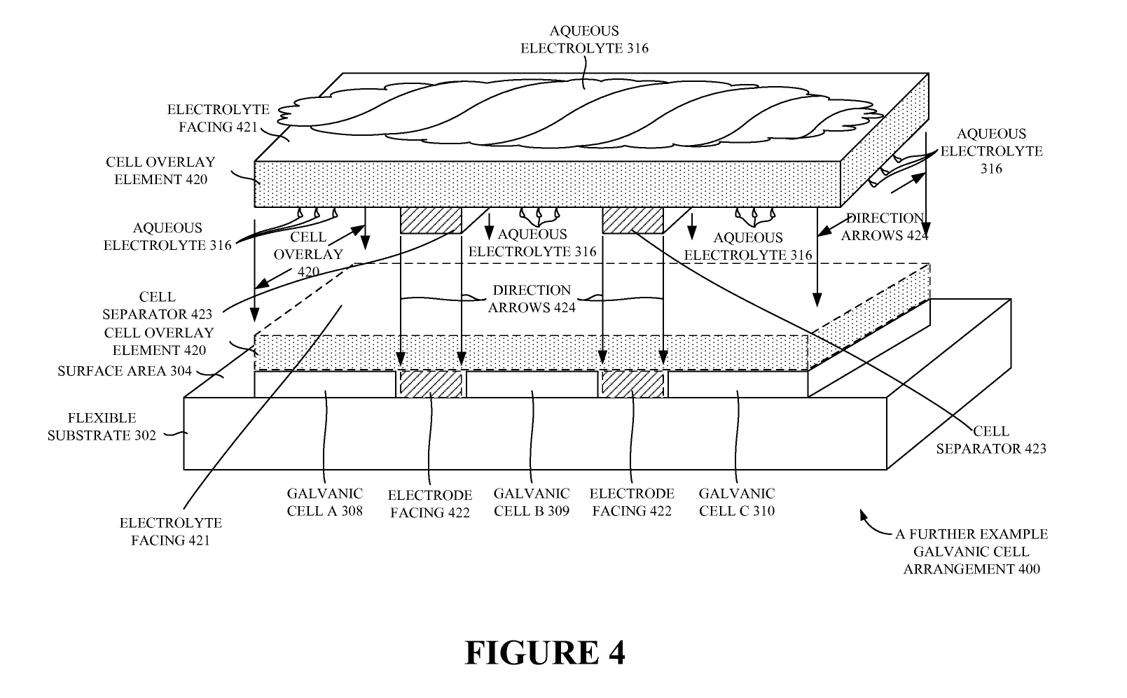

FIG. 4 illustrates a further example of galvanic cell arrangement 400, according to one or more embodiments. Particularly, FIG. 4 illustrates an aqueous electrolyte 316, cell overlay 420, an electrolyte facing 421, a cell separator 423, a flexible substrate 302, a galvanic cell A 308, an electrode facing 422, a galvanic cell B 309, and a galvanic cell C 310. In one or more embodiments, the galvanic cell arrangement may include a cell isolator positioned to surround each of the galvanic cells partially to electrically isolate the galvanic cells from one another. The cell isolator may include one or more cell overlay elements 420 positioned adjacent to each of the multiple galvanic cells and may be configured to electrically isolate the galvanic cells from one another. The cell overlay element 420 may include an electrolyte facing 421 portion and a cell facing (or electrode facing 422) portion. The electrolyte facing portion 421 may be configured to absorb the aqueous electrolyte 316, and the cell facing (or electrode facing 422) portion may be configured to expose the aqueous electrolyte 316 to the galvanic cells, and one or more cell separators (e.g., cell separator 423) may be positioned adjacent to each of the galvanic cells, and may be configured to electrically isolate the galvanic cells from one another. The cell separator 423 may be less absorptive than the cell overlay element 420.

In one or more embodiments, the cell overlay element 420 may be characterized by a porosity that may permit the cell facing portion 422 to expose the galvanic cells to the aqueous electrolyte 316 at a specific exposure rate that may relate to an acidity level of the aqueous electrolyte 316. The galvanic cell arrangement 400 may include a portion of the flexible substrate 302 configured to couple with the portable electronic device 316. In one or more embodiments, the portable electronic device 316 powered by the galvanic cell arrangement 400 may be configured to operate under water. The aqueous electrolyte 316 may include a solution of sodium and water. In one or more embodiments, a portion of the flexible substrate 302 may be configured to couple with the portable electronic device 316. The portable electronic device 316 may include a portable audio player, and the aqueous electrolyte 316 may include human perspiration. The portable electronic device 316 may include a probe that may be ingestible by an animal and the aqueous electrolyte 316 may include a gastric acid solution.

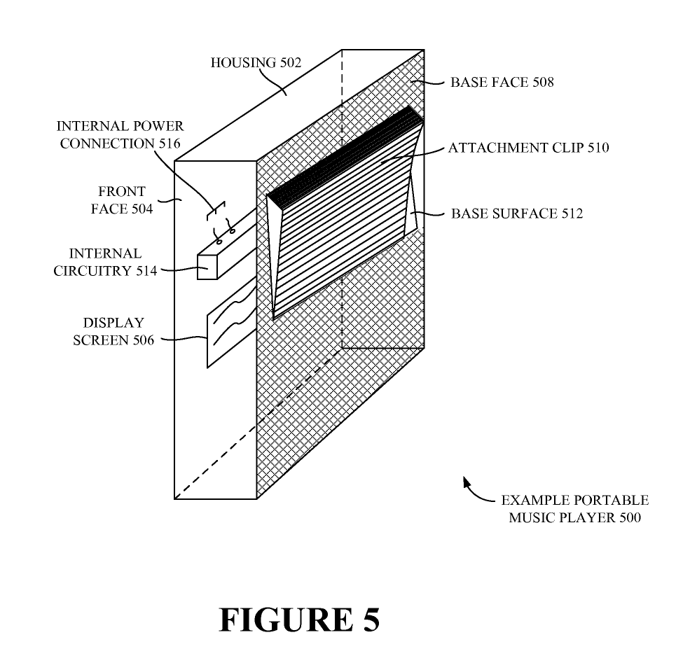

FIG. 5 illustrates an example of a portable music player 500 powered by a planar galvanic cell arrangement 300, according to one or more embodiments. In one or more embodiments, a base surface 612 of the portable music player 500 may be attached to a body surface of a user. Further, the planar galvanic cell arrangement 300 may be coupled to the portable music player 500 (e.g., an Mp3 player, i-pod, etc). The portable music player 500 may include a display screen 506 as illustrated in FIG. 5. The planar galvanic cell arrangement 300 may be attached to the surface of the portable music player 500 and may be clipped to a sweaty undergarment of a user of the portable music player 500. The sweat may act as the electrolyte for the planar galvanic cell arrangement 300. Further, the planar galvanic cell arrangement 300 may be coupled to the portable music player 500 through leads of an internal power connection 516 of an internal circuitry 514 of the portable music player 500 to supply power for operating the portable music player 500. In one or more embodiments, the leads of the internal power connection 516 of the portable music player may be provided on a front face 504 of the portable music player 500.

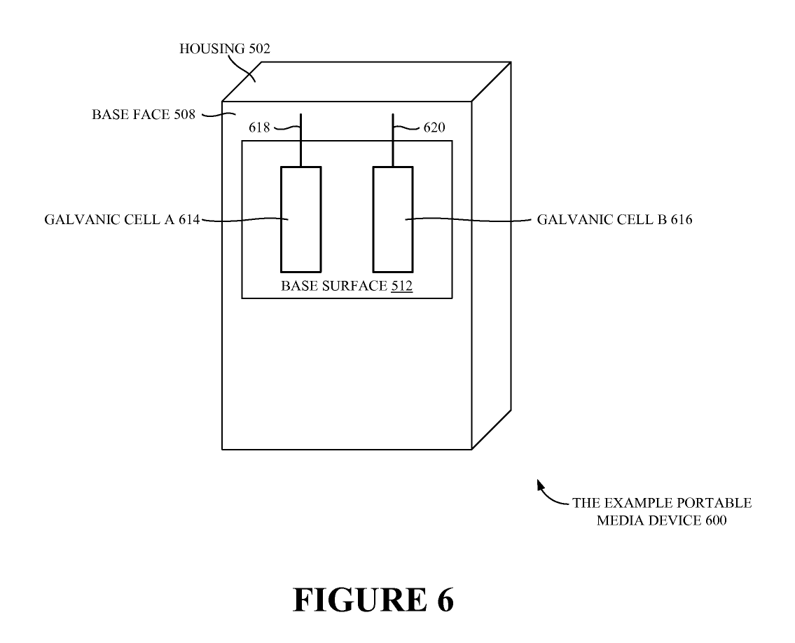

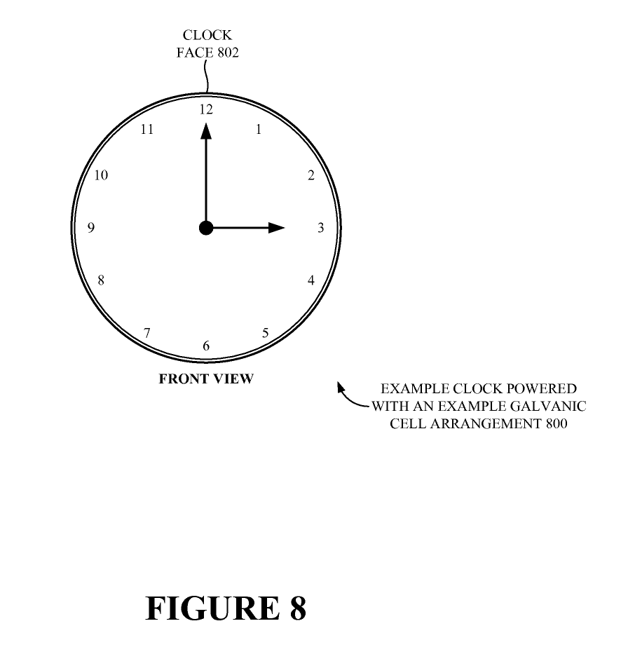

FIG. 6 illustrates an example of a portable media device 600 (e.g. portable music player 500) powered using a galvanic cell arrangement 300, according to one or more embodiments. Particularly, FIG. 6 illustrates a housing 502, a base face 508, galvanic cell A 614 and a galvanic cell B 616. In one or more embodiments, the housing 502 may include a flat external surface. An electronic circuit may be positioned within the housing and may be configured to perform a function of the portable electronic system (e.g., portable music player 500, portable media device 600, and clock 800 of FIG. 5, FIG. 6 and FIG. 8 respectively). The base surface 512 of the base face 508 of the portable media device 600 may include the galvanic cell A 614 and the galvanic cell B 616 placed adjacent to each other. The base face 508 of the portable media device 600 may be attached to a medium (e.g., a human body, sweaty apparels, etc) where the galvanic cell A 614 and the galvanic cell B 616 may use the sweat as the electrolyte to power the portable media device 600.

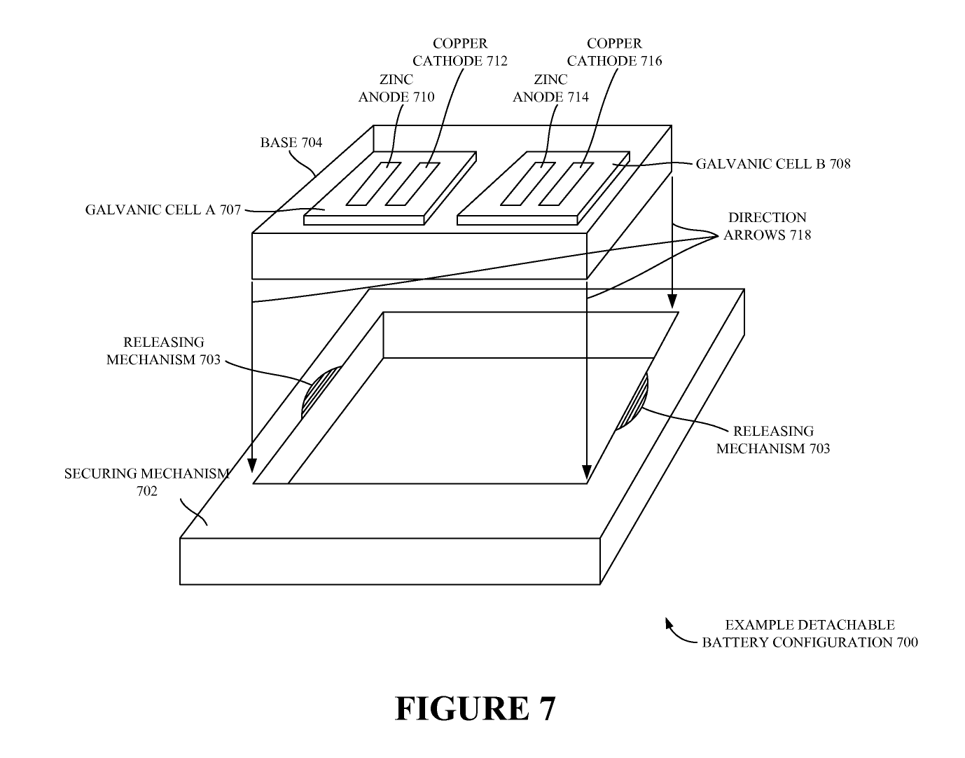

FIG. 7 illustrates an example of a detachable battery configuration 700 powered using a galvanic cell arrangement, according to one embodiments. The galvanic cell arrangement may be detachably attached to a securing mechanism 702. The galvanic cell arrangement of FIG. 7 includes a galvanic cell A 707 and a galvanic cell B 708. The galvanic cell A 707 may include a zinc anode 710 and a copper cathode 712. The galvanic cell B 708 may include a zinc anode 714 and a copper cathode 716. In one or more embodiments, the securing mechanism 702 may be used to attach the galvanic cells (e.g., the galvanic cell A 707 and the galvanic cell B 708) to the surface of an electronic device (e.g., portable music player 500, portable media device 800, clock 800, etc) by inserting a base 704 housing the galvanic cell A 707 and the galvanic cell B 708, into the securing mechanism 702 as indicated by the direction arrows 718. The releasing mechanism 703 may be used to release the galvanic cell arrangement from the securing mechanism to detach the galvanic cell arrangement from the surface of the electronic device (e.g., portable music player 500, portable media device 800, clock 800, etc) once the electronic device is charged. Zinc and copper electrodes may be used because zinc and copper are easily available and more economical in terms of cost. The electrodes may be changed based on the electrical potential required and the size of the planar galvanic cell required

FIG. 8 illustrates an example of a clock powered using a galvanic cell arrangement 800, according to one or more embodiments. In an embodiment, the planar galvanic cell arrangement may be coupled to the clock by attaching the galvanic cell arrangement to a clock surface 802. The clock may be for example a watch of a diver. In this embodiment, when the diver couples the galvanic cell arrangement 800 to the watch and dives into a sea, the sea water may act as the electrolyte. When one or more galvanic cells in the galvanic cell arrangement 800 come in contact with the electrolyte, the galvanic cells may generate power to operate the clock/watch of the diver.

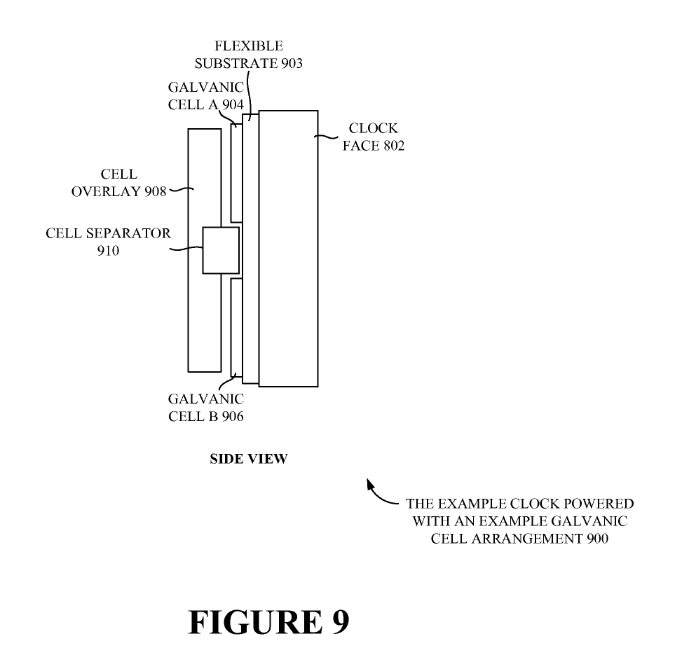

FIG. 9 illustrates an example a side view of a clock powered using an example galvanic cell arrangement, according to one or more embodiments. Further, FIG. 9 also illustrates the arrangement of a galvanic cell A 904 and a galvanic cell B 906 on the clock surface 802 using a flexible substrate 903. In one or more embodiments, the flexible substrate 903 used may include, but is not limited to a Kapton™ tape. The Kapton™ tape may provide flexibility to attach the galvanic cell arrangement on the surfaces of the portable electronic devices of any given shape. A cell overlay element 908 and the cell separator element 910 of the galvanic cell arrangement may be positioned adjacent to the galvanic cells and may be configured to electrically isolate the multiple galvanic cells from one another in the galvanic cell arrangement. Furthermore, the cell overlay element 908 may have some porosity which allows the electrolytic solution to pass through it and contact the electrode with the cell separator 910 being impermeable to provide the isolation, according to one embodiment.

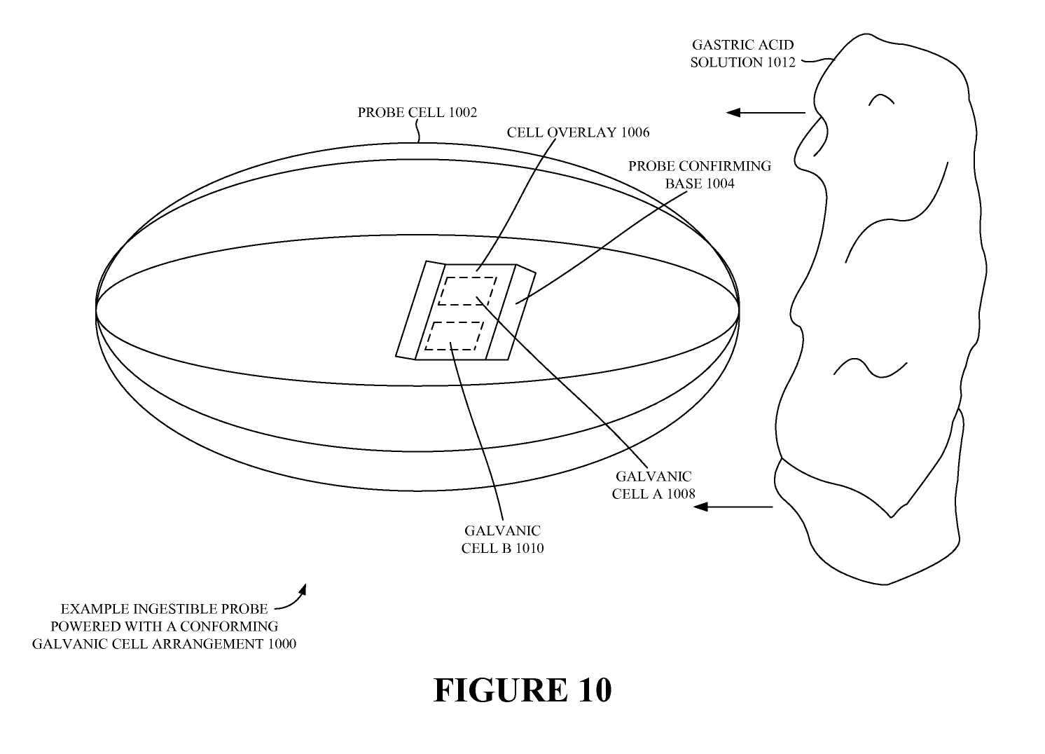

FIG. 10 illustrates an example of an ingestible probe powered with a conforming galvanic cell arrangement 1000, according to one or more embodiments. The conforming galvanic cell arrangement 1000 may include a galvanic cell A 1008 and a galvanic cell B 1010. In one or more embodiments, the galvanic cell A 1008 and the galvanic cell B 1010 may be coupled to a probe cell 1002 of the ingestible probe through a probe confirming base 1004. The galvanic cell A 1008 and the galvanic cell B 1010 may be attached to the surface of the probe cell 1002 that may be ingestible into a body of an animal. The galvanic cell arrangement 1000, when ingested into the body of the animal (e.g., into a digestive tract of the animal), comes in contact with gastric acid solution 1012 within the body of the animal. The gastric acid solution 1012 within the body (e.g., within the digestive tract) of the animal may serve as an aqueous electrolyte for the conforming galvanic cell arrangement 1000. The conforming galvanic cell arrangement 1000 may be powered on when the conforming galvanic cell arrangement 1000 comes in contact with the gastric acid solution 1012 and the ingestible probe may be powered by the conforming galvanic cell arrangement 1000. In the case of ingestible probes, as the galvanic cells may come in contact with strong acids and the galvanic cells may not last long, If the requirement of usage may be longer than 24 hours, then a less acidic solution would be preferred as electrolyte.

In one or more embodiments, a foam may used as a covering over the electrodes and may vary with the electrolyte being used. In one or more embodiments, the planar galvanic cell arrangement disclosed herein may be used to power low power consumer electronic devices. The power range of the low power consumer electronic devices may lie between 2V-5V. In one or more embodiments, the planar galvanic cell arrangement disclosed herein may generate approximately 0.5V with a pair of galvanic cells. For the purpose of illustration the detailed description refers sweat and sea water as aqueous electrolytes, however the scope of the invention disclosed is not limited to the sweat and sea water but may be extended to include any electrolyte. In a preferred embodiment, an underlying device on which the planar galvanic cell may be attached to should be water resistant depending on the environment in which the device may be used.

Although the present embodiments have been described with reference to specific example embodiments, it will be evident that various modifications and changes may be made to these embodiments without departing from the broader spirit and scope of the various embodiments. Accordingly, the specification and drawings are to be regarded in an illustrative rather than a restrictive sense.

What is claimed is:

1. A galvanic cell arrangement to provide electrical power to a portable electronic device, the galvanic cell arrangement comprising:
a flexible substrate including a surface area that forms a plane;
a plurality of galvanic cells coupled with the flexible substrate within the surface area that forms the plane, and electrically connected with one another in series, each of the plurality of galvanic cells including a negative electrode and a positive electrode; and
a first terminal coupled with the negative electrode at one end of the series, and second terminal coupled with the positive electrode at an opposite end of the series,
the plurality of galvanic cells being configured to provide electrical power to the portable electronic device via the first terminal and the second terminal, based on the plurality of galvanic cells being exposed to an aqueous electrolyte.

2. The galvanic cell arrangement of claim 1, wherein the negative electrode of each of the plurality of galvanic cells includes a zinc anode and the positive electrode of each of the plurality of galvanic cells includes a copper cathode.

3. The galvanic cell arrangement of claim 1, wherein the plurality of galvanic cells include a number of galvanic cells that depends on a voltage requirement of the portable electronic device, and cell potential of each galvanic cell of the plurality of galvanic cells to be exposed to the aqueous electrolyte.

4. The galvanic cell arrangement of claim 1, further comprising:
a cell isolator positioned to surround, at least partially, each of the plurality of galvanic cells so as to electrically isolate the plurality of galvanic cells from one another.

5. The galvanic cell arrangement of claim 4, wherein the cell isolator includes,
at least one cell overlay element positioned adjacent to each of the plurality of galvanic cells and configured to electrically isolate the plurality of galvanic cells from one another, wherein the at least one cell overlay element includes an electrolyte facing portion configured to absorb the aqueous electrolyte, and a cell facing portion configured to expose the aqueous electrolyte to the plurality of galvanic cells, and
at least one cell separator element positioned adjacent to each of the plurality of galvanic cells, and configured to electrically isolate the plurality of galvanic cells from one another, wherein the at least one cell separator element is less absorptive than the at least one cell overlay element.

6. The galvanic cell arrangement of claim 5, wherein the at least one cell overlay element is characterized by a porosity that permits the cell facing portion to expose the plurality of galvanic cells to the aqueous electrolyte at a specific exposure rate that relates to an acidity level of the aqueous electrolyte.

7. The galvanic cell arrangement of claim 1, wherein a portion of the flexible substrate is configured to couple with the portable electronic device, the portable electronic device is configured to operate under water, and the aqueous electrolyte includes a solution of sodium and water.

8. The galvanic cell arrangement of claim 1, wherein a portion of the flexible substrate is configured to couple with the portable electronic device, the portable electronic device includes a portable audio player, and the aqueous electrolyte includes human perspiration.

9. The galvanic cell arrangement of claim 1, wherein the portable electronic device includes a probe that is ingestible by an animal and the aqueous electrolyte includes a gastric acid solution.

10. An electrochemical cell arrangement, comprising:
a base member including a planar surface area; and
at least one pair of electrodes coupled with the planar surface area of the base member, and including a negative electrode and a positive electrode,
the at least one pair of electrodes being configured to operate as a voltage source responsive to the at least one pair of electrodes being exposed to an aqueous electrolyte.

11. The electrochemical cell arrangement of claim 10, wherein the negative electrode includes a metallic anode and the positive electrode includes a metallic cathode.

12. The electrochemical cell arrangement of claim 10, wherein the at least one pair of electrodes includes a plural number of pairs of electrodes that depends on a voltage requirement, a cell potential of each pair of electrodes of the plural number of pairs of electrodes, and a constitution of the aqueous electrolyte.

13. The electrochemical cell arrangement of claim 12, wherein the plural number of pairs of electrodes are electrically connected in series, and wherein the plural number of pairs of electrodes operating as the voltage source are configured to provide a voltage that is based on a summation of the cell potential of each pair of electrodes of the plural number of pairs of electrodes.

14. The electrochemical cell arrangement of claim 12, further comprising:
one or more cell separation elements positioned adjacent to, at least partially, each of the plural number of pairs of electrodes so as to electrically isolate, from one another, each of the plural number of pairs of electrodes.

15. The electrochemical cell arrangement of claim 12, further comprising:
a cell overlay element positioned adjacent to the plural number of pairs of electrodes and including an electrolyte facing portion configured to absorb the aqueous electrolyte, and an electrode facing portion configured to expose the plural number of pairs of electrodes to the aqueous electrolyte at a rate of exposure.

16. The electrochemical cell arrangement of claim 15, wherein the cell overlay element is characterized by a porosity that allows the electrode facing portion to expose a particular aqueous electrolyte to the plural number of pairs of electrodes at a specific rate of exposure.

17. The electrochemical cell arrangement of claim 10, wherein the at least one pair of electrodes is configured to power a portable electronic device when the at least one pair of electrodes is exposed to the aqueous electrolyte.

18. The electrochemical cell arrangement of claim 17, further comprising:
a securing mechanism configured to be coupled with the portable electronic device and to retain the at least one pair of electrodes; and
a releasing mechanism arranged with the securing mechanism and configured to release the retained at least one pair of electrodes from the securing mechanism,
the securing mechanism and the releasing mechanism thereby permitting the at least one pair of electrodes to be field replaceable by a user.

19. The electrochemical cell arrangement of claim 17, wherein the base member is configured to couple with the portable electronic device, the portable electronic device is configured to operate under water, and the aqueous electrolyte includes saline water.

20. The electrochemical cell arrangement of claim 17, wherein the base member is configured to attach with an animal and the aqueous electrolyte includes a bodily fluid of the animal.

21. A portable electronic system, comprising:
a housing including a flat external surface;
an electronic circuit positioned within the housing and configured to perform a function of the portable electronic system;
a plurality of galvanic cells coupled with the flat external surface of the housing, and electrically connected to one another in series, each of the plurality of galvanic cells including a negative electrode and a positive electrode;
a first terminal coupled to the negative electrode at one end of the series, and a second terminal coupled with the positive electrode at an opposite end of the series; and
a cell isolator positioned to surround, at least partially, each of the plurality of galvanic cells so as to electrically isolate the plurality of galvanic cells from one another,
the plurality of galvanic cells being configured to deliver electrical power to the electronic circuit via the first terminal and the second terminal when an aqueous electrolyte is transferred to the plurality of galvanic cells.
